(19) United States
(12) Patent Application Publication
(10) Pub. No.: US 2022/0407120 A1
(43) Pub. Date: Dec. 22, 2022

(54) BATTERY

(71) Applicant: TOYOTA JIDOSHA KABUSHIKI KAISHA, Toyota-shi (JP)

(72) Inventor: Yushi SUZUKI, Mishima-shi (JP)

(21) Appl. No.: 17/804,966

(22) Filed: Jun. 1, 2022

(30) Foreign Application Priority Data
Jun. 18, 2021 (JP) 2021-102031

(51) Int. Cl. H01M 10/0585; H01M 10/0525; H01M 4/66

(52) U.S. Cl. CPC H01M 10/0585; H01M 10/0525; H01M 4/666

(57) ABSTRACT

A battery having a plurality of series bodies including a first series body and a second series body, in which each of the series bodies has a plurality of electrode bodies and has at least one intermediate current collector, the series bodies is electrically connected in parallel to each other, in each of the series bodies, the electrode bodies are electrically connected in series to each other through the intermediate current collector, and the intermediate current collectors in the first series body and the second series body are directly connected electrically to each other.

### CROSS-REFERENCE TO RELATED APPLICATION

This application claims priority to Japanese Patent Application No. 2021-102031 filed on Jun. 18, 2021, incorporated herein by reference in its entirety.

### BACKGROUND

### 1. Technical Field

The present disclosure relates to a battery.

### 2. Description of Related Art

Japanese Unexamined Patent Application Publication No. 2014-116156 (JP 2014-116156 A) discloses a technique for electrically connecting a plurality of bipolar batteries in parallel to each other. The battery disclosed in JP 2014-116156 A includes a plurality of series bodies in which a plurality of electrode bodies (which may also be referred to as a plurality of unit batteries) is electrically connected in series to each other, and the series bodies can also be said to be electrically connected in parallel to each other. In addition, Japanese Unexamined Patent Application Publication No. 2018-028978 (JP 2018-028978 A) discloses a technique for electrically connecting at least two unit batteries in parallel to each other in a bipolar battery.

### SUMMARY

In a battery as disclosed in JP 2014-116156 A, when a peculiar capacity drop occurs in a part of a plurality of electrode bodies, there is a possibility that a voltage variation may become significant in a series body including the electrode bodies and, accordingly, the battery may deteriorate rapidly. It is difficult to suppress such rapid deterioration even with the technique disclosed in JP 2018-028978 A.

An aspect of the present disclosure relates to a battery having a plurality of series bodies including a first series body and a second series body. Each of the series bodies has a plurality of electrode bodies, each of the series bodies has at least one intermediate current collector, the series bodies are electrically connected in parallel to each other, in each of the series bodies, the electrode bodies are electrically connected in series to each other through the intermediate current collector, and the intermediate current collector in the first series body and the intermediate current collector in the second series body are directly connected electrically to each other.

In the aspect of the present disclosure, at least one of the series bodies may have a bipolar structure.

In the aspect of the present disclosure, the intermediate current collector may contain a resin and a conductive material.

In the battery in the aspect of the present disclosure, in the first series body, the number of the electrode bodies electrically connected in series to each other through the intermediate current collector may be two or three.

In the aspect of the present disclosure, the series bodies may be accommodated in one exterior body.

In the aspect of the present disclosure, the series bodies may be laminated with each other, in each of the series bodies, the electrode bodies may be laminated with each other, and a laminating direction of the series bodies may coincide with a laminating direction of the electrode bodies.

The battery in the aspect of the present disclosure may be an all-solid-state battery.

According to the aspect of the present disclosure, even when a peculiar capacity drop occurs in a part of the electrode bodies, it is easy to suppress a voltage variation in the series body including the electrode bodies.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view schematically showing the configuration of a battery;

FIG. 2 is a view schematically showing the configuration of the battery;

FIG. 3 is a view schematically showing the configuration of the battery;

FIG. 4 is a view schematically showing the configuration of the battery;

FIG. 5 is a view showing a voltage variation in a battery according to an example; and

FIG. 6 is a view showing a voltage variation in a battery according to a comparative example.

### DETAILED DESCRIPTION OF EMBODIMENTS

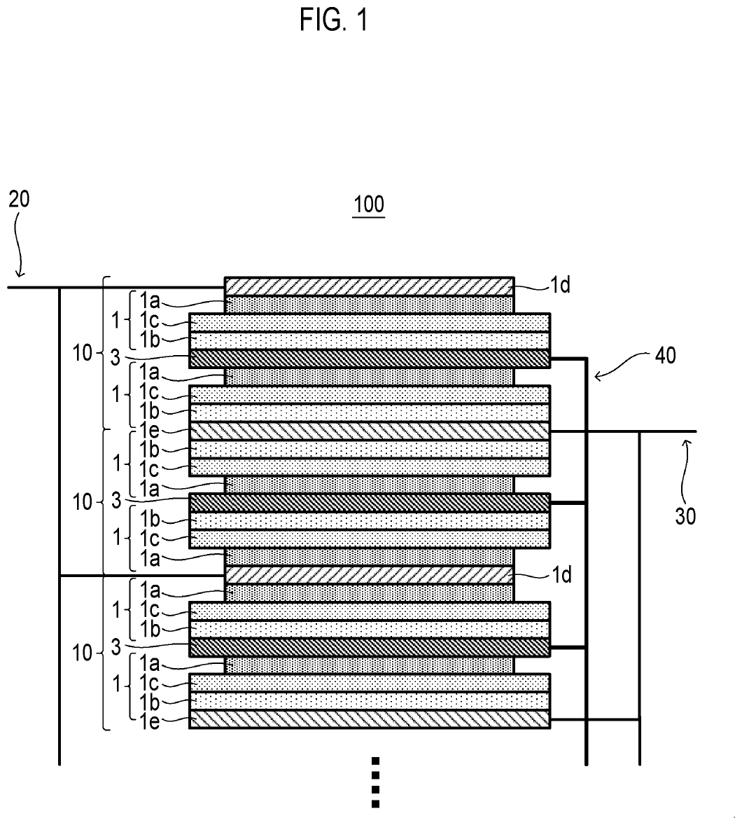

As shown in FIG. 1 to FIG. 3, a battery 100 according to an embodiment has a plurality of series bodies 10 including a first series body 10 and a second series body 10. In addition, each of the series bodies 10 has a plurality of electrode bodies 1. In addition, each of the series bodies 10 has at least one intermediate current collector 3. In addition, the series bodies 10 are electrically connected in parallel to each other. In addition, in each of the series bodies 10, the electrode bodies 1 are electrically connected in series to each other through the intermediate current collector 3. Furthermore, the intermediate current collector 3 in the first series body 10 and the intermediate current collector 3 in the second series body 10 are directly connected electrically to each other.

1. Series Body

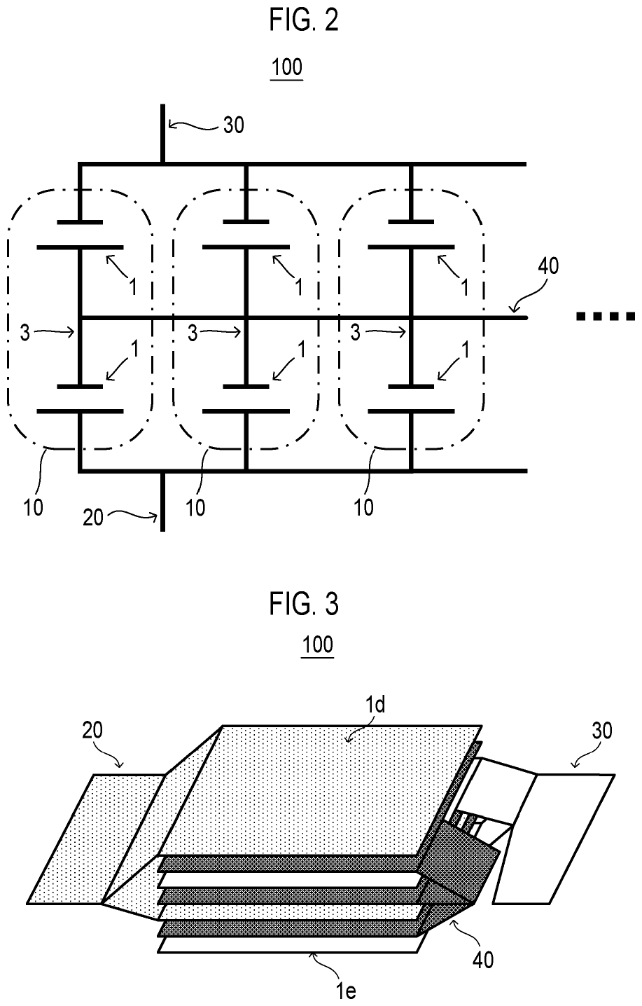

As shown in FIG. 1 and FIG. 2, the battery 100 has the series bodies 10 including the first series body 10 and the second series body 10. Each of the series bodies 10 has the electrode bodies 1 and at least one intermediate current collector 3. In each series body 10, the number of the electrode bodies 1 needs to be two or more and may be two, three, four or more. In addition, in each series body 10, the number of the intermediate current collectors 3 needs to be one or more and may be one, two, three or more.

2. Electrode Body

As shown in FIG. 1 and FIG. 2, each electrode body 1 is capable of configuring a unit battery. As shown in FIG. 1, each electrode body 1 may have a positive electrode active material layer 1a, a negative electrode active material layer 1b, and an electrolyte layer 1c. Each of the positive electrode active material layer 1a, the negative electrode active material layer 1b, and the electrolyte layer 1c can be easily obtained by a known molding method such as coating, transfer, or press molding.

2.1 Positive Electrode Active Material Layer

The positive electrode active material layer 1a may contain at least a positive electrode active material. In a case where the battery 100 is an all-solid-state battery, the positive electrode active material layer 1a may further optionally contain a solid electrolyte, a binder, a conductive auxiliary agent, and the like in addition to the positive electrode active material. In addition, in a case where the battery 100 is an electrolytic solution-based battery, the positive electrode active material layer 1a may further optionally contain a binder, a conductive auxiliary agent, and the like in addition to the positive electrode active material.

A known active material may be used as the positive electrode active material. Among known active materials, two substances having different potentials to occlude and discharge predetermined ions (charge and discharge potentials) are selected, a substance exhibiting a noble potential can be used as a positive electrode active material, and a substance showing a low potential can be used as a negative electrode active material to be described below, respectively. For example, in the case of configuring a lithium ion battery, as the positive electrode active material, a variety of lithium-containing composite oxides such as lithium cobalt oxide, lithium nickel oxide, LiNi_{1/3}Co_{1/3}Mn_{1/3}O₂, lithium manganate, and spinel-based lithium compounds can be used. In a case where the battery 100 is an all-solid-state battery, a coat layer such as a lithium niobate layer, a lithium titanate layer, or a lithium phosphate layer may be provided on a surface of the positive electrode active material in order to suppress a reaction caused by the contact between the positive electrode active material and the solid electrolyte. The positive electrode active material may be, for example, particulate, and a size of the positive electrode active material is not particularly limited.

In a case where the battery 100 is an all-solid-state battery, the solid electrolyte may be any of an organic solid electrolyte (polymer solid electrolyte) or an inorganic solid electrolyte. Particularly, inorganic solid electrolytes have a high ion conductivity compared with organic polymer electrolytes and are excellent in terms of heat resistance compared with organic polymer electrolytes. As the inorganic solid electrolyte, for example, oxide solid electrolytes such as lithium lanthanum zirconate, LiPON, Li_{1+X}Al_{X}Ge_{2-X}(PO₄)₃, Li—SiO-based glass, and Li—Al—S—O-based glass; sulfide solid electrolytes such as Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, and Li₂S—P₂S₅—GeS₂ can be exemplified. Among them, the sulfide solid electrolytes, particularly, a sulfide solid electrolyte containing Li₂S—P₂S₅ has high performance. The solid electrolyte may be, for example, particulate, and the size of the solid electrolyte is not particularly limited.

Examples of the binder include a butadiene rubber (BR)-based binder, a butylene rubber (IIR)-based binder, a styrene-butadiene rubber (SBR)-based binder, an acrylate-butadiene rubber (ABR)-based binder, a polyvinylidene fluoride (PVdF)-based binder, and a polytetrafluoroethylene (PTFE)-based binder.

Examples of the conductive auxiliary agent include carbon materials such as acetylene black or Ketjen black and metal materials such as nickel, aluminum, and stainless steel. The conductive auxiliary agent may be, for example, particulate or fibrous, and the size of the conductive auxiliary agent is not particularly limited.

A content of each component in the positive electrode active material layer 1a may be set to the same as that in known batteries. The shape of the positive electrode active material layer 1a may also be set to the same as that in known batteries. The positive electrode active material layer 1a may have a sheet shape since the battery 100 can be more easily configured. The thickness of the positive electrode active material layer 1a is not particularly limited. For example, the thickness may be 0.1 μm or more and 2 mm or less. The lower limit may be 1 μm or more, and the upper limit may be 1 mm or less.

2.2 Negative Electrode Active Material Layer

The negative electrode active material layer 1b may contain at least a negative electrode active material. In a case where the battery 100 is an all-solid-state battery, the negative electrode active material layer 1b may further optionally contain a solid electrolyte, a binder, a conductive auxiliary agent, and the like in addition to the negative electrode active material. In addition, in a case where the battery 100 is an electrolytic solution-based battery, the negative electrode active material layer 1b may further optionally contain a binder, a conductive auxiliary agent, and the like in addition to the negative electrode active material.

A known active material may be used as the negative electrode active material. For example, in the case of configuring a lithium ion battery, as the negative electrode active material, a silicon-based active material such as Si, a Si alloy or silicon oxide; a carbon-based active material such as graphite or hard carbon; a variety of oxide-based active materials such as lithium titanate; metallic lithium, a lithium alloy, or the like can be used. The negative electrode active material may be, for example, particulate, and the size of the negative electrode active material is not particularly limited. The solid electrolyte, the binder and the conductive auxiliary agent can be appropriately selected and used from those exemplified as those that are used in the positive electrode active material layer 1a.

The content of each component in the negative electrode active material layer 1b may be set to the same as that in known batteries. The shape of the negative electrode active material layer 1b may also be set to the same as that in known batteries. The negative electrode active material layer 1b may have a sheet shape since the battery 100 can be more easily configured. The thickness of the negative electrode active material layer 1b is not particularly limited. For example, the thickness may be 0.1 μm or more and 2 mm or less. The lower limit may be 1 μm or more, and the upper limit may be 1 mm or less. The thickness or laminated area (electrode area) of the negative electrode active material layer 1b may be adjusted so that the capacity of a negative electrode becomes larger than the capacity of a positive electrode.

2.3 Electrolyte Layer

An electrolyte can be disposed in the positive electrode active material layer 1a and the negative electrode active material layer 1b as described above and also can be disposed as the electrolyte layer 1c between the positive electrode active material layer 1a and the negative electrode active material layer 1b. As the electrolyte layer 1c, any of ordinary electrolyte layers for batteries can be adopted. The electrolyte layer 1c contains at least an electrolyte. In a case where the battery 100 is an all-solid-state battery, the electrolyte layer 1c may contain a solid electrolyte and, optionally, a binder. Regarding the solid electrolyte, as described above, particularly, inorganic solid electrolytes, more particularly, sulfide solid electrolytes have high performance. As the binder, the same binder as the binder that is used in the positive electrode active material layer 1a can be appropriately selected and used.

The content of each component in the electrolyte layer 1c may be set to the same as that in known batteries. The shape of the electrolyte layer 1c may also be set to the same as that in known batteries. The electrolyte layer 1c may have a sheet shape since the battery 100 can be more easily configured. The thickness of the electrolyte layer 1c may be, for example, 0.1 μm or more and 2 mm or less. The lower limit may be 1 μm or more, and the upper limit may be 1 mm or less.

On the other hand, in a case where the battery 100 is an electrolytic solution-based battery, the electrolyte layer 1c may contain an electrolytic solution and a separator. As the electrolytic solution or the separator, a known electrolytic solution or separator may be used. In the case of comparing a case where the electrolyte layer 1c is a liquid-based electrolyte layer and a case where the electrolyte layer 1c is a solid electrolyte layer, it is considered that it becomes easier to configure the battery 100 in a case where the electrolyte layer 1c is a solid electrolyte layer, that is, a case where the battery 100 is an all-solid-state battery. Particularly, in the all-solid-state battery rather than the electrolytic solution-based battery, it is easy to configure a bipolar structure in the series body 10.

2.4 Positive Electrode Current Collector and Negative Electrode Current Collector

As shown in FIG. 1, in the battery 100, at least a part of the electrode bodies 1 may have a positive electrode current collector 1d or a negative electrode current collector 1e. As the positive electrode current collector 1d and the negative electrode current collector 1e, any of ordinary current collectors for batteries can be adopted. The positive electrode current collector 1d and the negative electrode current collector 1e may be a metal foil or a metal mesh. In particular, a metal foil is excellent in terms of handleability and the like. The positive electrode current collector 1d and the negative electrode current collector 1e may each be made up of a plurality of metal foils.

Examples of a metal that configures the positive electrode current collector 1d and the negative electrode current collector 1e include Cu, Ni, Cr, Au, Pt, Ag, Al, Fe, Ti, Zn, Co, and stainless steel. In particular, the positive electrode current collector 1d may contain Al from the viewpoint of maintaining oxidation resistance, and the negative electrode current collector 1e may contain Cu from the viewpoint of maintaining reduction resistance.

The positive electrode current collector 1d and the negative electrode current collector 1e may have any coating layer on the surface for the purpose of adjusting resistance or the like. In addition, in a case where the positive electrode current collector 1d and the negative electrode current collector 1e are made of a plurality of metal foils, any layer may be provided between the metal foils. The thicknesses of the positive electrode current collector 1d and the negative electrode current collector 1e are not particularly limited. For example, the thicknesses may be 0.1 μm or more or 1 μm or more and may be 1 mm or less or 100 μm or less.

3. Intermediate Current Collector

As shown in FIG. 1 and FIG. 2, in one series body 10, the electrode bodies 1 is electrically connected in series to each other through the intermediate current collector 3. That is, the intermediate current collector 3 can be disposed between the positive electrode active material layer 1a of one electrode body 1 and the negative electrode active material layer 1b of another electrode body 1. From the viewpoint of being capable of easily maintaining a high voltage, increasing energy density, and the like, the series body 10 may have a bipolar structure, and, in this case, the intermediate current collector 3 may be a bipolar current collector. That is, as shown in FIG. 1, the positive electrode active material layer 1a may be laminated on one surface of the intermediate current collector 3, and the negative electrode active material layer 1b may be laminated on the other surface.

The intermediate current collector 3 may be made of metal. Alternatively, as described below, the intermediate current collector 3 may contain a resin and a conductive material. The intermediate current collector 3 may be made up of a plurality of layers (or foils). In a case where the intermediate current collector 3 is made of metal, examples of the metal that configures the intermediate current collector 3 include Cu, Ni, Cr, Au, Pt, Ag, Al, Fe, Ti, Zn, Co, and stainless steel. The intermediate current collector 3 may have any coating layer on the surface for the purpose of adjusting resistance or the like. The thickness of the intermediate current collector 3 is not particularly limited. For example, the thickness may be 0.1 μm or more or 1 μm or more and may be 1 mm or less or 100 μm or less.

In a case where the intermediate current collector 3 contains a resin and a conductive material, the weight of the battery 100 is likely to be reduced, and the safety of the battery 100 is likely to improve. The resin may be, for example, a vinyl resin. In addition, the conductive material may be, for example, a carbon material or a metal material. As the metal material, the same metal material as the above-described metal can be adopted. The shape of the conductive material is not particularly limited and may be, for example, particulate. The intermediate current collector 3 may be obtained by, for example, molding a mixture of the above-described resin and conductive material into a foil shape. The ratio between the resin and the conductive material in the intermediate current collector 3 is not particularly limited as long as the current collector maintains a fixed form, mechanical characteristics, and a conductive property high enough to electrically connect the electrode bodies 1 in series to each other.

4. Electrical Connection

As shown in FIG. 1 to FIG. 3, the battery 100 has at least three kinds of electrical connection such as parallel connection between the series bodies 10, serial connection between the electrode bodies 1 in the series body 10, and direct connection between the intermediate current collector 3 in the first series body 10 and the intermediate current collector 3 in the second series body 10.

4.1 Parallel Connection Between Series Bodies

As shown in FIG. 1 to FIG. 3, in the battery 100, the series bodies 10 are electrically connected in parallel to each other. The series bodies 10 may be electrically connected to each other by, for example, projecting positive electrode current collector tabs 20 from the positive electrode current collectors 1d, projecting negative electrode current collector tabs 30 from the negative electrode current collectors 1e, integrating the positive electrode current collector tabs 20 together by bundling and integrating the negative electrode current collector tabs 30 together by bundling, by fixing or integrating terminals or the like to the positive electrode current collectors 1d or the negative electrode current collectors 1e and electrically connecting the terminals together, or by other methods.

When the electrode bodies 1 are connected in series to each other to configure the series body 10, it is possible to maintain a high voltage as described below, but it is difficult to maintain a sufficient capacity of the battery as a whole by connecting the electrode bodies 1 in series. In contrast, in the battery 100, the series bodies 10 are electrically connected in parallel, whereby the capacity of the battery 100 as a whole increases. The number of the series bodies 10 that are electrically connected in parallel can be appropriately determined depending on the target capacity of the battery. In the battery 100, the number of the series bodies 10 needs to be plural and may be two or more, three or more, four or more, and five or more.

4.2 Serial Connection Between Electrode Bodies

As shown in FIG. 1 to FIG. 3, in one series body 10, the electrode bodies 1 are electrically connected in series to each other through the intermediate current collector 3. In the battery 100, the electrode bodies 1 may be electrically connected in series to each other by a known method. For example, the positive electrode of one electrode body 1 is disposed on one surface of the intermediate current collector 3, and the negative electrode of another electrode body 1 is disposed on the other surface, whereby the one electrode body 1 and another electrode body 1 can be electrically connected in series. As described above, the series body 10 may have a bipolar structure, that is, the intermediate current collector 3 may be a bipolar current collector.

The number of the electrode bodies 1 in one series body 10 is not particularly limited; however, when the number is small, it becomes easier to monitor and estimate the voltage of each electrode body 1, and the safety is also easily improved. Based on this respect, the number of the electrode bodies 1 that are electrically connected in series to each other through the intermediate current collector 3 in one series body 10 may be two or three. In a case where one electrode body has a voltage of approximately 3.5 V to 4.5 V, a series body and a battery having a voltage of approximately 12 V can be obtained by connecting three of the electrode bodies in series. A battery having a voltage of approximately 12 V is convenient and highly demanded.

4.3 Direct Connection Between Intermediate Current Collectors

As shown in FIG. 1 to FIG. 3, in the battery 100, the intermediate current collector 3 of the first series body 10 and the intermediate current collector 3 of the second series body 10 are directly connected electrically to each other. “Being directly connected electrically” means that there is a direct conduction path between the intermediate current collector 3 of the first series body 10 and the intermediate current collector 3 of the second series body 10 with no electrode body 1 therebetween. That is, the battery 100 has a direct conduction path between the intermediate current collectors 3 separately from the parallel connection between the series bodies 10 and the serial connection between the electrode bodies 1.

The intermediate current collector 3 of the first series body 10 and the intermediate current collector 3 of the second series body 10 may be directly connected by, for example, as shown in FIG. 1 to FIG. 3, projecting intermediate current collector tabs 40 from the intermediate current collectors 3 and integrating the intermediate current collector tabs 40 together by bundling, by fixing or integrating terminals or the like to the intermediate current collectors 3 and electrically connecting the terminals together, or by other methods.

In the battery 100, in a case where a plurality of the intermediate current collectors 3 is included in one series body 10 (that is, in a case where three or more electrode bodies are connected in series), at least one of the intermediate current collectors 3 included in the first series body 10 and at least one of the intermediate current collectors 3 included in the second series body 10 need to be directly connected electrically. In addition, the intermediate current collectors 3 of the second series body 10 may be directly connected electrically to one intermediate current collector 3 of the first series body 10.

In a case where the intermediate current collectors 3 are directly connected electrically to each other separately from the parallel connection between the series bodies 10 and the serial connection between the electrode bodies 1 as described above, even when a peculiar capacity drop occurs in a specific electrode body 1, a current is dispersed into the series body 10 including the electrode body 1 and a different series body 10 to make the voltage balanced, and, in the series body 10 including the electrode body 1 where the capacity drop occurs, a voltage variation is easily suppressed.

5. Laminated Structure

The battery 100 may have a predetermined laminated structure. For example, as shown in FIG. 1 and FIG. 3, in the battery 100, the series bodies 10 may be laminated together, and, in each of the series bodies 10, the electrode bodies 1 may be laminated together, and the laminating direction of the series bodies 10 and the laminating direction of the electrode bodies 1 may coincide with each other. More specifically, the positive electrode active material layer 1a of one electrode body 1 may be laminated on one surface of the intermediate current collector 3, and the negative electrode active material layer 1b of another electrode body 1 may be laminated on the other surface, the positive electrode active material layer 1a of one electrode body 1 may be laminated on one surface of the positive electrode current collector 1d, and the positive electrode active material layer 1a of another electrode body 1 may be laminated on the other surface, and the negative electrode active material layer 1b of one electrode body 1 may be laminated on one surface of the negative electrode current collector 1e, and the negative electrode active material layer 1b of another electrode body 1 may be laminated on the other surface. In such a case, the one electrode body 1 and another electrode body 1 are electrically connected in series, and the first series body 10 and the second series body 10 can be electrically connected in parallel. In other words, a laminated body of the electrode bodies 1 and the intermediate current collectors 3 having both a serial connection structure (which may be a bipolar structure) and a parallel connection structure can be obtained. The battery 100 may be configured by, as shown in FIG. 1, electrically connecting the positive electrode current collectors 1d to each other, the negative electrode current collectors 1e to each other, and the intermediate current collectors 3 to each other through the above-described tabs and the like on the side surfaces of the laminated body obtained as described above.

6. Other Members

The battery 100 may have different members other than the above-described members. Members to be described below are examples of the different members that the battery 100 may have.

6.1 Exterior Body

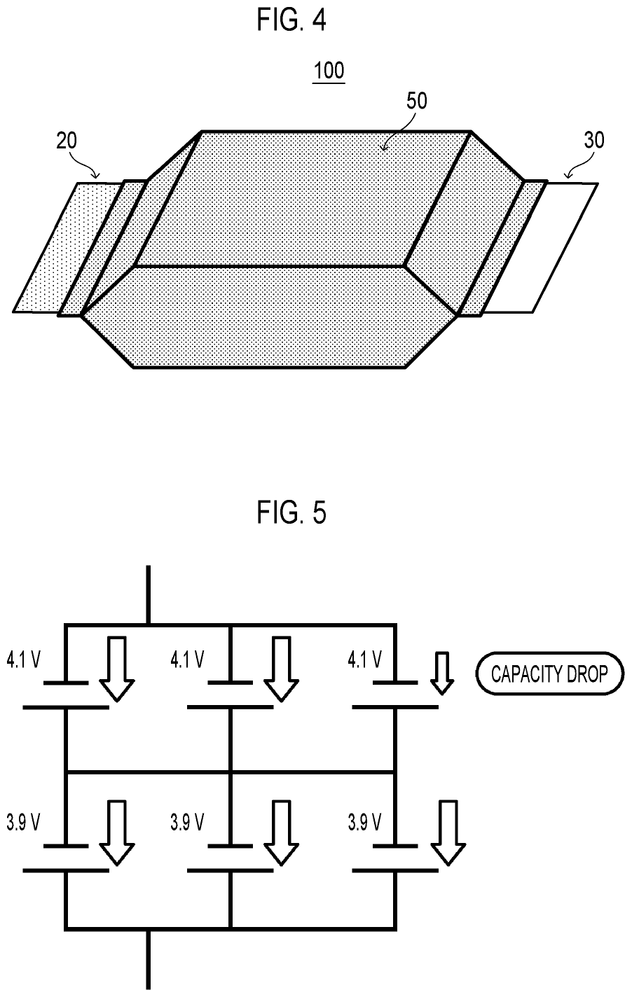

As shown in FIG. 4, in the battery 100, the series bodies 10 may be accommodated in one exterior body 50. More specifically, the portions excluding the tabs 20 and 30 (or the terminals and the like) for extracting electric power from the battery 100 to the outside may be accommodated in one exterior body 50. In addition, in the battery 100, at least a part of the intermediate current collectors 3 and the tabs 40 may be present outside the exterior body 50 or all of the tabs 40 and the intermediate current collectors 3 may be accommodated in the exterior body 50. Particularly, in a case where all of the tabs 40 and the intermediate current collectors 3 are accommodated in the exterior body 50 (in other words, in a case where the intermediate current collectors 3 are not pulled out to the outside of the exterior body 50), it is easy to avoid interference between the intermediate current collectors 3 and the positive electrode current collector tabs 20 or the negative electrode current collector tabs 30, and the sealing of the exterior body 50 is also easy.

As the exterior body 50, any of known exterior bodies for batteries can be adopted. For example, a laminated film may be used as the exterior body 50. In addition, a plurality of the batteries 100 may be electrically connected and optionally stacked, thereby forming an assembled battery. In this case, the assembled battery may be accommodated in a known battery case.

6.2 Sealing Resin

In the battery 100, the series bodies 10 may be sealed with a resin. For example, the series bodies 10 are laminated to configure a laminated body as shown in FIG. 1, and then at least a side surface (a surface along the laminating direction) of the laminated body may be sealed with a resin. Thus, it easy to suppress the mixing or the like of moisture into the inside of the electrode body 1. As the sealing resin, a known thermosetting resin or thermoplastic resin can be adopted. In the battery 100, the series bodies 10 may be accommodated in the above-described exterior body 50 in a state of being sealed with the resin.

6.3 Voltage Monitoring Device

The battery 100 may have a device for monitoring the voltage of each of the electrode bodies 1. Any of known devices for monitoring the voltage of the electrode body 1 can be adopted.

6.4 Restraint Member

The battery 100 may have a restraint member for restraining the electrode bodies 1. For example, in a case where the series bodies 10 are laminated to configure a laminated body as described above, a restraining pressure may be imparted in the laminating direction to the laminated body with the restraint member. Particularly, in a case where the battery 100 is an all-solid-state battery, when a restraining pressure is imparted with the restraint member, it is easy to reduce the internal resistance of the electrode bodies 1.

Hereinafter, the effects of the battery of the present disclosure will be described in more detail while describing examples, but the battery of the present disclosure is not limited to the following examples. In the following examples, an all-solid-state battery in which a solid electrolyte is used as an electrolyte will be exemplified, but the applicable scope of the technique of the present disclosure is not limited to all-solid-state batteries. It is considered that the same effects can be exhibited even in a case where the technique of the present disclosure is applied to liquid-based batteries. However, a bipolar structure is configured more easily in all-solid-state batteries than in liquid-based batteries.

### 1. Examples

1.1 Production of Positive Electrode Mixture

A positive electrode active material (LiNi_{1/3}Co_{1/3}Mn_{1/3}O₂), a solid electrolyte (LiI—LiBr—Li₂S—P₂S₅), a conductive auxiliary agent (VGCF), and a binder (ABR) were mixed at predetermined ratios to obtain a positive electrode mixture.

1.2 Production of Negative Electrode Mixture

A negative electrode active material (graphite), a solid electrolyte (LiI—LiBr—Li₂S—P₂S₅), and a binder (ABR) were mixed at predetermined ratios to obtain a negative electrode mixture.

1.3 Production of Electrolyte Mixture

A solid electrolyte (LiI—LiBr—Li₂S—P₂S₅) and a binder (ABR) were mixed at a predetermined ratio to obtain an electrolyte mixture.

1.4 Production of Battery

A laminated body having a configuration shown in FIG. 1 was produced using positive electrode active material layers obtained from the above-described positive electrode mixture, electrolyte layers obtained from the electrolyte mixture, negative electrode active material layers obtained from the negative electrode mixture, positive electrode current collectors (aluminum foils), negative electrode current collectors (copper foils), and intermediate current collectors (resin foils obtained by molding a mixture of a vinyl resin and conductive particles into a foil shape). Here, the number of electrode bodies electrically connected in series through the intermediate current collector in one series body was set to two. In addition, three series bodies were electrically connected in parallel. In addition, as shown in FIG. 1 and FIG. 3, on the side surfaces of the laminated body, a tab was projected from each current collector, and then the positive electrode current collectors, the negative electrode current collectors, and the intermediate current collectors were directly connected electrically to each other using the tabs. After the connection of the current collectors, the laminated body was sealed in a laminated film as an exterior body to obtain a battery for evaluation. Here, as shown in FIG. 4, a part of the positive electrode current collector tabs and the negative electrode current collector tabs were pulled out to the outside of the laminated film through a sealing material.

### 2. Comparative Example

A battery was obtained in the same manner as in the example except that the intermediate current collectors were not directly connected electrically to each other.

### 3. Evaluation Results

FIG. 5 shows an example of the configuration of the battery according to the example and a voltage variation in a case where the capacity of a part of the electrode bodies has peculiarly dropped. As shown in FIG. 5, in the battery according to the example, the intermediate current collectors were directly connected electrically to each other, whereby, even when a peculiar capacity drop occurred in a specific electrode body, the voltages were balanced between the series body including the electrode body and other series bodies, and it was easy to suppress a voltage variation in the series body including the electrode body.

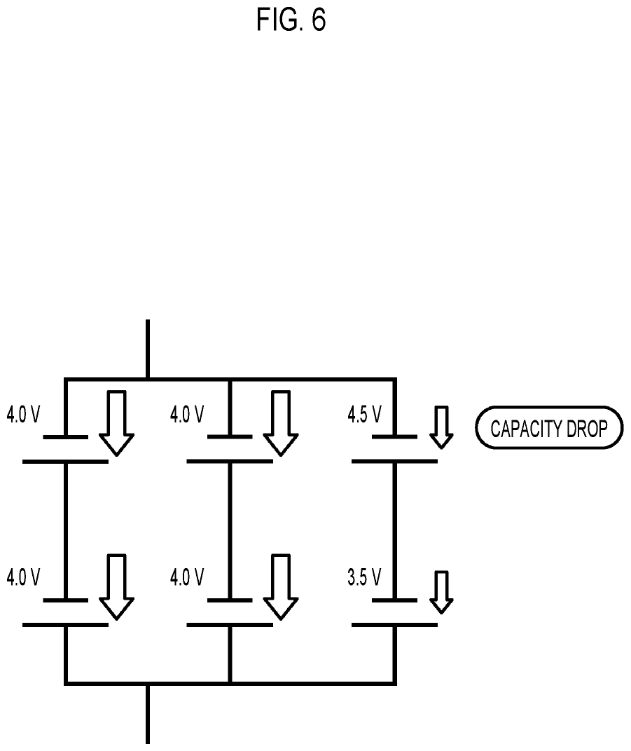

FIG. 6 shows an example of the configuration of the battery according to the comparative example and a voltage variation in a case where the capacities of a part of the electrode bodies have peculiarly dropped. As shown in FIG. 6, in the battery according to the comparative example, when a peculiar capacity drop occurred in a specific electrode body, a voltage variation became significant in the series body including the electrode body, and there was a possibility of the rapid deterioration of the battery.

As described above, in a battery in which a plurality of series bodies including a plurality of electrode bodies connected in series to each other is provided and the series bodies is connected in parallel to each other, in order to suppress a voltage variation between the electrode bodies, it can be said that it is effective to electrically connect the intermediate current collectors to each other. Specifically, the battery may have the following configuration.

The battery has a plurality of series bodies including a first series body and a second series body, in which each of the series bodies has a plurality of electrode bodies, each of the series bodies has at least one intermediate current collector, the series bodies are electrically connected in parallel to each other, in each of the series bodies, the electrode bodies are electrically connected in series to each other through the intermediate current collector, and the intermediate current collector in the first series body and the intermediate current collector in the second series body are directly connected electrically to each other.

What is claimed is:

1. A battery comprising a plurality of series bodies including a first series body and a second series body, wherein:
each of the series bodies has a plurality of electrode bodies;
each of the series bodies has at least one intermediate current collector;
the series bodies are electrically connected in parallel to each other;
in each of the series bodies, the electrode bodies are electrically connected in series to each other through the intermediate current collector; and
the intermediate current collector in the first series body and the intermediate current collector in the second series body are directly connected electrically to each other.

2. The battery according to claim 1, wherein at least one of the series bodies has a bipolar structure.

3. The battery according to claim 1, wherein the intermediate current collector contains a resin and a conductive material.

4. The battery according to claim 1, wherein, in the first series body, the number of the electrode bodies electrically connected in series to each other through the intermediate current collector is two or three.

5. The battery according to claim 1, wherein the series bodies are accommodated in one exterior body.

6. The battery according to claim 1, wherein:
the series bodies are laminated with each other;
in each of the series bodies, the electrode bodies are laminated with each other; and
a laminating direction of the series bodies coincides with a laminating direction of the electrode bodies.

7. The battery according to claim 1, wherein the battery is an all-solid-state battery.
